(19) United States
(12) Patent Application Publication
(10) Pub. No.: US 2002/0026509 A1
(43) Pub. Date: Feb. 28, 2002

(54) Supply of a service or an application with a set QoS category

(75) Inventor: Stefan Wahl, Schwieberdingen (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 09/918,503

(22) Filed: Aug. 1, 2001

(30) Foreign Application Priority Data
Aug. 30, 2000 (DE) 100 42 509.7

(51) Int. Cl. G06F 15/173; G06F 15/16

(52) U.S. Cl. 709/224; 709/217

(57) ABSTRACT

In the method according to the invention, to supply a service or an application, a service required by a customer or an application required by the customer is linked to a QoS category selected by the customer and the required service or the required application is supplied to the customer with the QoS category selected by the customer. In a first embodiment version of the method according to the invention a request to supply a service or an application is received from a terminal of the customer in the resources management unit and a request is transmitted to the customer to select one of at least two QoS categories. The selected QoS category is received from the terminal in the resources management unit and the requested service or the requested application is supplied to the terminal with the selected QoS category by the resources management unit.

### TECHNICAL FIELD

The invention relates to the supply of a service or an application with a set QoS category; QoS=Quality of Service.

The invention is based on a priority application DE 100 42 509.7 which is hereby incorporated by reference.

### BACKGROUND OF THE INVENTION

Services and applications are supplied in, among other things, access systems. Access systems of this kind are, for example, structured as so-called shared medium access systems. An access system of this kind is, for example, an HFC system, an HFR system, an LMDS system or an XDSL system; HFC=Hybrid Fibre Coax, HFR=Hybrid Fibre Radio, LMDS=Local Multipoint Distribution System; XDSL=X Digital Subscriber Line, wherein X stands, for example, for asynchronous, synchronous, very high-speed, etc. In access systems of this kind a point-to-multipoint network is usually constructed for transmission from a mainframe or dependent mainframe, e.g. a head end or base station, to the terminals of the customers, e.g. cable modems or radio stations. A multipoint-to-point network is constructed for transmission from the terminals to the mainframe or dependent mainframe. A large number of services and applications is supplied to the customer. These are, e.g., interactive services such as service on demand for providing speech and/or image services, services for transmitting data, Internet services, cable television, telephony, e.g. the so-called voiceover IP, IP=Internet Protocol and banking services for on-line banking.

Intelligent resources management with QoS is needed to achieve fair and adequate distribution of the available resources to customers, services and applications. By QoS, the so-called quality of service, is understood the transmission quality of a connection. For an image or video connection, for example, a higher transmission quality is needed than for a purely speech or audio connection.

The availability and reliability of the bandwidth both in the direction from the mainframe or dependent mainframe to the terminals of the customers and in the direction from the terminals to the mainframe or dependent mainframe has to be managed.

QoS categories are, for example:

a) Premium Service, where there are high QoS requirements, e.g. with respect to the maximum time delay within a cell, the jitter and in the setup of virtual, leased lines,

b) Assured Service, where there are lower requirements than with the Premium Service and where more variability as well as so-called bursty traffic is possible

c) Best Effort Service, where there are the lowest requirements.

Nowadays a set QoS category is pre-allocated to each service and each application. When a service is selected by the customer, e.g. by transmitting an appropriate request for supply of a service to a mainframe, the mainframe automatically makes a set bandwidth available, corresponding to the QoS category for the selected service. The bandwidth to be made available is rigidly pre-determined for each service and each application for the direction from the mainframe to the terminals of the customers and in the direction from the terminals to the mainframe.

If, for example, a Premium Service application is requested and there is no longer sufficient bandwidth available, the application cannot and is not made available.

### SUMMARY OF THE INVENTION

The object of the invention is to make alternative QoS management available.

This object is achieved respectively by a method of supplying a service or an application, comprising the steps:

a service required by a customer or an application required by the customer is linked to a QoS category selected by the customer and the required service or the required application is supplied to the customer with the QoS category selected by the customer and a mainframe for supplying services and/or applications for customers whose terminals are connected to the mainframe, said mainframe being capable, on request by a customer for a service or application, of supplying this service or the application with a QoS category corresponding to a QoS category selected by the customer and/or of changing the QoS category in a supplied service or a supplied application on receipt of a request from the customer to change the QoS category.

The customer is given the opportunity of personally selecting the QoS category for each service and each application. In addition he/she is given the opportunity, e.g. of changing the QoS category on-line, in other words during operation, in other words during a connection. The selection of a QoS category takes place, e.g. on each request to receive a selection list from the mainframe. The mainframe communicates, e.g., three possibilities, which can be selected by indicating with a cross or similar. The selection list contains limitations, if applicable; e.g. for cable television only the Premium Service and the Assured Service can be selected, but not the Best Effort Service. Limitation occurs, e.g., for technical or commercial reasons. The selection of a QoS category can alternatively take place by communicating a selection of a QoS category at the same time as the request for supply of a service or an application. A customer can thus deal with the selection of the QoS category at the same time as the selection of the service or the application. A further possibility for selecting QoS categories consists in that for individual customers or for every customer a table is stored in the mainframe, in which a pre-selection by the customer is entered. A customer once selects, e.g., a certain configuration, which is then stored in the mainframe and to which the mainframe has access on each request for a service or application. If a customer requests a service, the mainframe determines the customer's individual QoS category via the table and thereupon makes available to him/her the appropriate bandwidth for the required service. The configuration can contain the same QoS category, e.g. Assured Service, for all the services and applications or different QoS categories for different categories of services, e.g. Assured Service for all image connections and Best Effort Service for all data and speech connections.

The invention thus provides flexible QoS management, defined by the customer. The invention is a novel feature of performance which can be implemented in particular in access systems. If there is not sufficient bandwidth for a connection with a high QoS category, the customer can choose a lower QoS category and thus avail him/herself of a service or application, even if with lower quality than originally desired. The mainframe in this case makes available to the customer, for example, suitable alternatives for selection. An advantage for the customer is independent stipulation of connection costs by appropriate selection of the QoS category, as a higher QoS category usually results in higher connection costs. It is also conceivable that there are package deals for the configurations pre-selected by the customer. Further, the QoS category can be, in addition or alternatively to the time of day, a further or the parameter for deciding the current fees.

Advantageous configurations of the invention can be seen in the dependent patent claims and the following description.

### BEST MADE FOR CARRYING OUT THE INVENTION

An embodiment example of the invention is explained below.

An Internet connection (IP connection) requested by a customer is, for example, provided via an IP router, an ATM switch and an access system; ATM=Asynchronous Transfer Mode. At the beginning of the application the customer has the choice of selecting a QoS category for the connection. Each QoS category has a number of parameters. All the parameters have default settings. Each parameter can be changed. The customer is, for example, informed by a resources management unit with an MAC (Medium Access Control) about which QoS category has which current default parameters. The default parameters can, e.g., vary depending on the time of day. Parameters are, for example, the bandwidth, the maximum delay jitter, the cost, etc. The customer can then transmit his/her selection to the MAC. The MAC will provide the appropriate application with the selected QoS category. In order to be able to carry out a selection, a special software management tool is installed in each case in the resources management unit and with the customer. The customer's software tool, which is designed as a computer program, is installed on a terminal of the customer. The terminal is, for example, a cable modem or a PC (personal computer) or a radio station. The software tool serves to obtain access to the resources management unit and to the fee registration centre. The fee registration centre can then inform the customer, for example on-line, of the latest fees for a current application. The resources management unit is arranged, for example, in a mainframe, a dependent mainframe, a head end, a base station or a so-called Access Network Adaptation. A Software Management Tool corresponding to the software tool of the customer is installed in the resources management unit. This software tool enables provision of telemetric selection of QoS categories. At least parts of this tool are installed in the fee registration centre.

To summarise, with the method according to the invention for supplying a service or an application a service required by a customer or an application required by the customer is thus linked to a QoS category selected by the customer and the required service or the required application is supplied to the customer with the QoS category selected by the customer.

In a first embodiment version of the method according to the invention a request to supply a service or an application is received from a terminal of the customer in the resources management unit and a request for selection of one of at least two QoS categories is transmitted to the customer. In the resources management unit the selected QoS category is received from the terminal and the requested service or the requested application is supplied to the terminal with the selected QoS category by the resources management unit.

In a second embodiment version of the method according to the invention a request to supply a service or an application is received from a terminal of the customer in the resources management unit, wherein the request comprises one of at least two QoS categories, which have been pre-selected by the customer. The requested service or the requested application is supplied to the terminal with the selected QoS category.

In a third embodiment version of the method according to the invention a request to supply a service or an application is received from a terminal of the customer in the resources management unit and then a stored pre-selection of a QoS category by the customer is accessed. The service required by the customer or the application required by the customer is linked in the resources management unit to the QoS category pre-selected by the customer. The required service or the required application is then supplied to the customer with the QoS category selected by the customer.

In all three embodiment versions it can be provided as an additional feature that the selected and supplied QoS category can be changed by the customer during the period of supply of the service or the application by transmitting a new selected QoS category.

In a fourth embodiment version the feature that the selected and supplied QoS category can be changed by the customer during the period of supply of the service or application by transmitting a new selected QoS category can also be implemented independently. For example, each connection required by a customer for service or application is started initially with default values. The customer thus receives a connection immediately without selecting parameters of a QoS. The customer can then decide during the connection to change the QoS category. Reasons for doing this can be, e.g.

During an Internet session image construction is too slow for the customer. By appropriate changing of the QoS category image construction can be speeded up for the following images.

Or during the period of connection an announcement relating to fees is transmitted. If the session or the phone call or similar is becoming too expensive for the customer, he/she can reduce the current fees by appropriate changing of the QoS category, e.g. by down-grading thereof.

The possibility of changing the QoS category only during connection but not at the beginning of it has the following advantages: customers who do not want to bother with selecting a QoS category immediately receive a connection without time delay and without having to make a selection. Customers who wish to select a QoS category also immediately receive a connection and can observe the differences between two QoS categories on-line. In order to avoid, e.g., disadvantages through default values which may be set too high and therefore over-high fees, billing of fees starts, for example, only after a certain period of time, e.g. ten seconds, after the connection has been set up. Active customers have by then made their selection of QoS category.

In all four embodiment versions selection of the QoS categories can, for example, instead of or in addition to selection of individual parameters, be done via an icon comprising a simple control in respect of the quality. By continuous or stepped adjustment, i.e. shifting the control, more or less quality can be requested in a simple manner.

The mainframe according to the invention for supplying services and/or applications for customers whose terminals are connected to the mainframe is capable, on request of a customer for a service or application, of supplying this service or the application with a QoS category corresponding to a QoS category selected by the customer. The mainframe has for this purpose a data carrier with a computer program. The computer program is capable of linking a QoS category selected by a customer to a service required by the customer or an application required by the customer. The mainframe comprises an arithmetic unit, e.g. a processor on which the computer program is implemented. The arithmetic unit works, for example, with a normal programming language such as C or C++. The computer program code elements carry out the steps of the method to be implemented.

In the third embodiment version the mainframe has access to a memory, in which for at least some of the customers at least one pre-selected QoS category is stored. The memory is located in the mainframe or a suitable place outside the mainframe. The mainframe is capable, on request by a customer for a service or application, of supplying this service or the application with a QoS category corresponding to the QoS category stored for the customer. If no QoS category is stored for a customer the default values are used.

The mainframe is, for example, structured as a resources management unit, a head end or a base station.

The terminal of a customer has a data carrier, e.g. a RAM, with a computer program. The computer program is characterised in that it comprises computer program code elements which enable selection of at least one QoS category when the computer program is run on a computer. As computer an arithmetic unit is here understood, which, e.g., can be: a processor, a DSP (Digital Signal Processor), a microprocessor, a so-called FPGA, a processing unit in a telephone, a processing unit in a cable modem or a personal computer or a card thereof. In a further configuration the computer program enables the selection of parameters of at least one QoS category. The terminal of the customer is, for example, structured as a cable modem, a personal computer, a telephone, a television set, a radio station or a mobile radio unit.

1. Method of supplying a service or an application, comprising the steps:
a service required by a customer or an application required by the customer is linked to a QoS category selected by the customer and the required service or the required application is supplied to the customer with the QoS category selected by the customer.

2. Method according to claim 1, comprising the steps:
a request to supply a service or an application is received from a terminal of the customer, a request to select one of at least two QoS categories is transmitted to the customer, the selected QoS category is received from the terminal and the requested service or the requested application is supplied with the selected QoS category.

3. Method according to claim 1, comprising the steps:
a request to supply a service or an application is received from a terminal of the customer, the request comprises one of at least two QoS categories, pre-selected by the customer, and the requested service or the requested application is supplied with the selected QoS category.

4. Method according to claim 1, comprising the steps:
a request to supply a service or an application is received from a terminal of the customer, a saved pre-selection of a QoS category by the customer is accessed, the service required by the customer or the application required by the customer is linked to the QoS category pre-selected by the customer and the required service or the required application is supplied to the customer with the QoS category selected by the customer.

5. Method according to claim 1, comprising the steps:
a supplied QoS category can be changed by the customer during the period of supply of a service or an application by transmitting a new QoS category.

6. Mainframe for supplying services and/or applications for customers whose terminals are connected to the mainframe, said mainframe being capable, on request by a customer for a service or application, of supplying this service or the application with a QoS category corresponding to a QoS category selected by the customer and/or of changing the QoS category in a supplied service or a supplied application on receipt of a request from the customer to change the QoS category.

7. Mainframe according to claim 6, said mainframe having access to a memory in which at least one pre-selected QoS category is stored for at least some of the customers and the mainframe is capable, on request by a customer for a service or application, of supplying this service or this application with a QoS category corresponding to the QoS category stored for the customer.

8. Mainframe according to claim 6, said mainframe being structured as a resources management unit, a head end or a base station.

9. Computer program, comprising a computer program code elements which enable selection of at least one QoS category when the computer program is run on a computer.

10. Computer program according to claim 9, enabling selection of parameters of at least one QoS category.

11. Terminal, comprising a data carrier with a computer program according to claim 9.

12. Terminal according to claim 11, comprising a cable modem, a personal computer, a telephone, a television set, a radio station or a mobile radio unit.

13. Computer program, capable of linking a QoS category selected by a customer to a service required by the customer or an application required by the customer.
